(19) United States
(12) Patent Application Publication
(10) Pub. No.: US 2014/0203724 A1
(43) Pub. Date: Jul. 24, 2014

(54) LED DRIVER CIRCUIT

(71) Applicant: Princeton Technology Corporation, New Taipei City (TW)

(72) Inventor: Ming-Yuan TSAO, New Taipei City (TW)

(21) Appl. No.: 13/928,000

(22) Filed: Jun. 26, 2013

(30) Foreign Application Priority Data
Jan. 21, 2013 (TW) 102102162

(51) Int. Cl. H05B 33/08

(52) U.S. Cl. CPC H05B 33/0815
USPC 315/224

(57) ABSTRACT

A LED driving circuit is provided. The LED driving circuit includes: an output transistor, having a drain coupled to an LED; a node, coupled to a source of the output transistor; a ground transistor, having a drain coupled to the node, and a source coupled to the ground; an operational amplifier, including: an input stage, for receiving a driving signal and a feedback signal, including a first input end and a second input end; and an output stage, for providing an output signal to a gate of the output transistor; and a first switch assembly, coupled to the driving signal, the feedback signal and the input stage of the operational amplifier, for providing the driving signal to one of the first input end and the second input end of the operational amplifier and coupling the node to the other of the first input end and the second input end of the operational amplifier.

### CROSS REFERENCE TO RELATED APPLICATIONS

This Non-provisional application claims priority under 35 U.S.C. §119(a) on Patent Application No(s).102102162, filed in Taiwan, Republic of China on Jan. 21, 2013, the entire contents of which are hereby incorporated by reference.

### BACKGROUND OF THE INVENTION

1. Field of the Invention

The present invention is related to LED driving circuits, and in particular, related to LED driving circuits that suppress brightness error.

2. Description of the Related Art

In a LED display, brightness errors often occur among different modules because of the driving current variations thereof. For a full-color display, when the driving current is inaccurate, the screen is prone to color blocks, and the display quality is negatively affected.

Brightness errors usually occur due to inter-channel current errors or inter-chip current errors. The inter-chip current errors are caused due to process drift between different ICs which are manufactured in different batches. Though it is difficult to prevent process drifts, there are various manners in the prior art to deal with the inter-chip current errors. The contemporary approaches have limited effect on obliterating the inter-chip current errors.

In general, the human eyes can discern the brightness difference of 6% or above, and the human eyes can even discern the brightness difference of 1% for low-brightness image frames. Thus, merely obviating the inter-chip current errors is insufficient to meet the requirements of today's high-definition displays. In view of this deficiency, the present invention provides new LED drivers that suppress brightness errors of the LED display by reducing the inter-channel current errors.

### BRIEF SUMMARY OF THE INVENTION

The present invention provides a LED driving circuit. The LED driving circuit comprises: an output transistor, having a drain coupled to an LED; a node, coupled to a source of the output transistor; a ground transistor, having a drain coupled to the node, and a source coupled to the ground; an operational amplifier, comprising: an input stage, for receiving a driving signal and a feedback signal, and comprising a first input end and a second input end; and an output stage, for providing an output signal to a gate of the output transistor; and a first switch assembly, coupled to the driving signal, the feedback signal and the input stage of the operational amplifier, for providing the driving signal to one of the first input end and the second input end of the operational amplifier and coupling the node to the other of the first input end and the second input end of the operational amplifier.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a driving circuit for a LED according to the prior art.

FIG. 2 is a schematic diagram of the LED driving circuit according to an embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

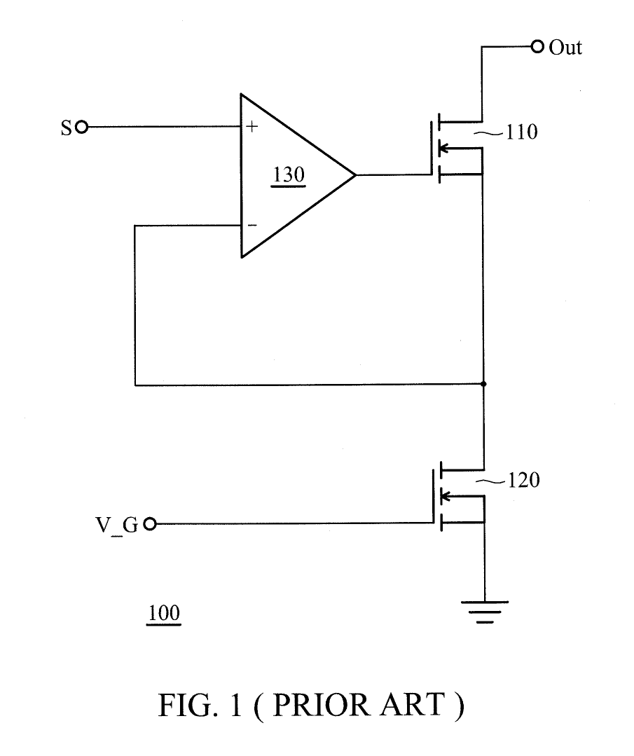

FIG. 1 is a schematic diagram of a driving circuit for a LED according to the prior art. In FIG. 1, the LED driving circuit 100 comprises an output NMOS transistor 110, a ground NMOS transistor 120, and an operational amplifier 130. The output NMOS transistor 110 has a drain and a source, where the drain is coupled to an output end Out, and the source is connected in series to the drain of the ground NMOS transistor 120. The output end Out is further connected to a LED (Not shown). The ground NMOS transistor 120 has a gate and a source, where the gate is used to receive a bias voltage V_G, and the source is grounded. The operational amplifier 130 receives a driving signal S and a feedback signal, and has an output coupled to a gate of the NMOS transistor 110. With such negative feedback configuration, the operational amplifier 130 outputs a voltage to the gate of the NMOS transistor 110, so that the voltage of the grounded drain of the NMOS transistor 120 maintains the same with the node S. The operational amplifier 130 enables the NMOS transistor 120 to operate in a linear region, and steers the LED driving current to the ground via the output end Out.

It is noteworthy that the inter-channel current errors are caused by: (1) the NMOS transistor 120; and (2) the bias difference of the operational amplifier 130. To reduce the inter-channel current errors caused by the NMOS transistor 120, the transistor area usually has to be enlarged, thereby increasing costs. The LED driving circuit of the present invention is aimed to lower the influences of the bias difference of the operational amplifier.

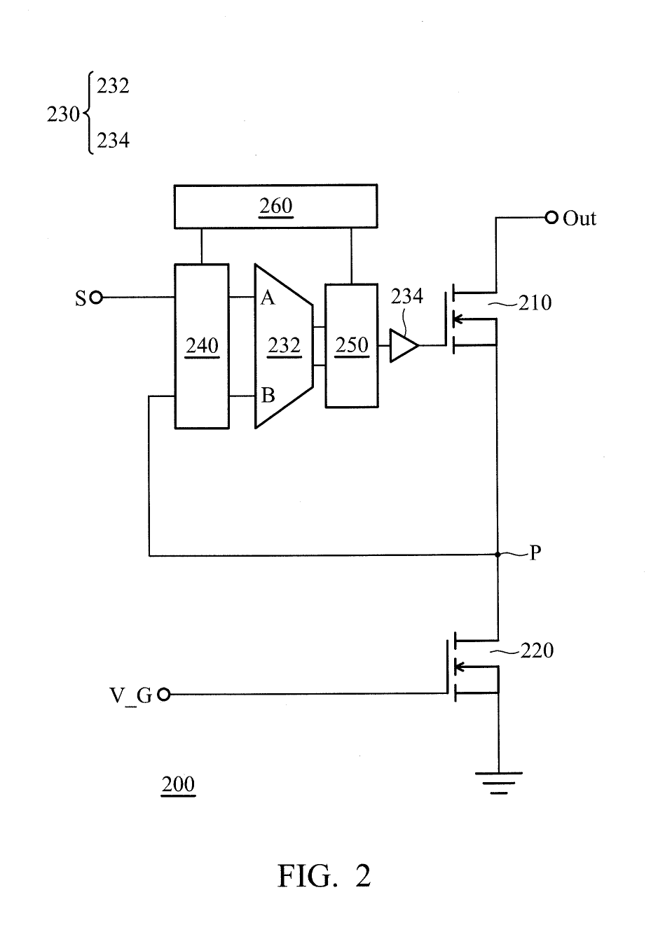

FIG. 2 is a schematic diagram of the LED driving circuit according to an embodiment of the present invention. In this embodiment, the LED driving circuit 200 comprises: an output transistor 210, a ground transistor 220, an operational amplifier 230, a first switch assembly 240, a second switch assembly 250, and a switch controller 260. These components will be described in the following in accordance with FIG. 2.

In the embodiment of FIG. 2, the output transistor 210 and the ground transistor 220 are both NMOS transistors. The output transistor 210 has a drain and a source, where the drain is coupled to the output end Out and further coupled to a LED (not shown), and the source is coupled to a node P. The ground transistor has a drain, a source and a gate, where the drain is coupled to the node P, the source is grounded, and the gate is coupled to a bias voltage V_G, as shown in FIG. 2.

The operational amplifier 230 of the present invention is used to receive a driving signal S, and enables the transistor 220 to constantly operate in the linear area. In this invention, the operational amplifier 230 can be divided into two stages: an input stage 232 and an output stage 234. The input stage 232 is used to receive the driving signal S and a feedback signal (from node P). The output stage 234 is coupled to the gate of the output transistor 210. The input stage 232 comprises an input end A and an output end B. Please refer to FIG. 1. In the prior art, when the operational amplifier is operating in a negative feedback configuration, one input end of the operational amplifier is used to receive the driving signal, and the other input end of the operational amplifier is used to receive a feedback signal provided by the transistor. Due to process drift, it is difficult for the voltages on the two input ends of the operational amplifier 230 to remain identical with each other, thereby inducing the bias difference on the node P and affecting the current accuracy. The operational amplifier 230 of the present invention is different from the prior art by alternately allowing both input ends thereof to receive the driving signal S. The operational amplifier 230 of the present invention will be further described in the following.

To suppress the bias difference described above, the present invention provides a first switch assembly 240 and a second switch assembly 250. In an embodiment, the first switch assembly 240 is coupled to the driving signal S, the node P and the input stage 232 of the operational amplifier 230, and the second switch assembly 250 is coupled between the input stage 232 and the output stage 234 of the operational amplifier 230. The first switch assembly 240 can be used to provide the driving signal S to one input end of the operational amplifier 230, and connect the node P to the other input end of the operational amplifier 230. With the first switch assembly 240, the node S and the node P can be interchangeably connected to the two input ends of the input stage 232 of the operational amplifier 240. The second switch assembly 250 operates in coordination with the first switch assembly 240 to synchronously switch the polarity of the input ends of the input stage 232, so as to allow the operational amplifier 230 to operate constantly in the negative feedback mode. Specifically, in an embodiment, through the first switch assembly 240 and the second switch assembly 250, the LED driving circuit 200 of the present invention can operate in two modes: a first mode and a second mode.

Under the first mode, the first switch assembly 240 provides the driving signal S to the input end A of the operational amplifier 230, and connects the node P to the input end B of the operational amplifier 230. In this embodiment, the operational amplifier 230 and the output transistor 210 are connected to each other in the same manner as shown in FIG. 1, and the second switch assembly 250 does not need to change the polarity of the input ends of the operational amplifier 230. Meanwhile, the polarity of the input end A is positive, and the polarity of the input end B is negative.

Adversely, under the second mode, the first switch assembly 240 provides the driving signal S to the input end B of the operational amplifier 230, and connects the node P to the input end A of the operational amplifier 230. In this embodiment, the operational amplifier 230 and the output transistor 210 are connected to each other in a different manner with FIG. 1. To maintain the negative feedback configuration, the second switch assembly 250 has to change the polarity of the input ends of the operational amplifier 230. Under this condition, the polarity of the input end A is negative, and the polarity of the input end B is positive.

To make sure that the first switch assembly 240 and the second switch assembly 250 operates normally, the LED driving circuit of the present invention further comprises a switch controller 260. The switch controller 260 of the present invention can not only coordinate the operation between the first switch assembly 240 and the second switch assembly 250, but also can control the switching frequency of the first switch assembly 240 and the second switch assembly 250. Those skilled in the art can set an appropriate switching frequency based on specifications of the components of the LED driving circuit 200 (for example, response time), and thus the details in connection with the setting of the switching frequency will not be given herein.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A LED driving circuit, comprising:
an output transistor, having a drain coupled to a LED, a gate, and a source;
a node, coupled to the source of the output transistor;
a ground transistor, having a drain coupled to the node, and a source coupled to ground;
an operational amplifier, comprising:
an input stage, for receiving a driving signal and a feedback signal, comprising a first input end and a second input end; and
an output stage, for providing an output signal to the gate of the output transistor; and
a first switch assembly, coupled to the driving signal, the feedback signal and the input stage of the operational amplifier, for providing the driving signal to one of the first input end and the second input end of the operational amplifier and coupling the node to the other of the first input end and the second input end of the operational amplifier.

2. The LED driving circuit as claimed in claim 1, further comprising a second switch assembly, coupled between the input stage and the output stage of the operational amplifier, for switching the polarity of the input stage to be correspondent with the output signal.

3. The LED driving circuit as claimed in claim 2, wherein when the first switch assembly provides the driving signal to the first input end of the operational amplifier, the second switch assembly maintains the polarity of the driving signal outputted by the input stage, and when the first switch assembly provides the driving signal to the second input end of the operational amplifier, the second switch assembly changes the polarity of the driving signal outputted by the input stage.

4. The LED driving circuit as claimed in claim 1, further comprising a switch controller, for controlling a switch frequency of the first switch assembly and the second switch assembly.

5. The LED driving circuit as claimed in claim 1, wherein the output transistor is a N-channel metal-oxide-semiconductor field-effect transistor.

6. The LED driving circuit as claimed in claim 1, wherein the ground transistor is a N-channel metal-oxide-semiconductor field-effect transistor.

7. The LED driving circuit as claimed in claim 1, wherein a gate of the ground transistor is coupled to a bias voltage.
